(19) United States
(12) Patent Application Publication
(10) Pub. No.: US 2013/0337669 A1
(43) Pub. Date: Dec. 19, 2013

(54) LOCKING DEVICE FOR ELECTRIC VEHICLE CHARGING CONNECTOR

(71) Applicants: Gerardo Rodriguez Najera, San Nicolas de los Garza (MX); Saul Lopez Rangel, Monterrey (MX); Jose Matilde Martinez Amador, Apodaca (MX)

(72) Inventors: Gerardo Rodriguez Najera, San Nicolas de los Garza (MX); Saul Lopez Rangel, Monterrey (MX); Jose Matilde Martinez Amador, Apodaca (MX)

(73) Assignee: Schneider Electric USA, Inc., Palatine, IL (US)

(21) Appl. No.: 13/495,467

(22) Filed: Jun. 13, 2012

(51) Int. Cl. H01R 13/44; E05B 65/00

(52) U.S. Cl. 439/133; 70/174; 403/322.1

(57) ABSTRACT

A latch-locking device for an electric vehicle charging connector having a movable latching element for engaging a matching latching element on a charging station, or on an electric vehicle. The latch-locking device includes a movable latch-locking element mounted adjacent the matching latching element on the charging station or an electric vehicle for movement, in a direction transverse to the direction of movement of the movable latching element, between a retracted position spaced away from the matching latching element and an advanced position where the latch-locking element overlaps at least a portion of the movable latching element when the movable latching element is engaged with the matching latching element. An actuator is coupled to the latch-locking element for moving the locking element between the retracted and advanced positions.

### FIELD OF THE INVENTION

The present invention relates generally to the charging of electric vehicles and, more particularly to the locking of the electrical connectors used for the charging of electric vehicles.

### BACKGROUND OF THE INVENTION

The charging of electric vehicles may be performed in a variety of different locations that have electric vehicle charging stations (EVCSs), also referred to as electric vehicle supply equipment (EVSE). In the United States, the current standard for the “conductive charge coupler” used in an EVCS to connect an electrical power source to the electrical system of an electric vehicle, to charge the vehicle battery, is the SAE J1772 standard. This standard applies to both the electrical inlet in the vehicle and the connector used to couple an electrical charging system to the vehicle inlet. The purpose of the coupler is to transfer energy to charge the battery and operate other vehicle electrical systems, to establish a reliable equipment grounding path, and to exchange control information between the vehicle and the supply equipment. The vehicle is typically equipped with an on-board charger capable of accepting energy from a single-phase AC supply network, converting the AC to DC, and regulating the supply voltage to a level that permits a managed charge rate based on the battery charge acceptance characteristics.

The J1772 connector and vehicle inlet include mating sets of electromechanical contacts that provide a physical connection at the vehicle interface for the power conductors, an equipment grounding conductor, a control pilot conductor, and a proximity sense conductor to provide a signal that helps reduce electrical arcing of the coupler during disconnect. Thus, the interface typically has five contacts that perform the interface functions. In addition, the coupler includes a latching mechanism to prevent inadvertent or accidental decoupling. The latching mechanism may also serve to properly align the connector with the vehicle inlet by requiring a latch element projecting from the connector to be registered with a cooperating latch element in the vehicle inlet.

An EVCS typically includes a docking station for stowing the electrical connector on the power cord when the connector is not being used. In the docking station, the mechanical receptacle for the connector on the end of the power cord is usually similar to the electrical receptacle in an electric vehicle, but without the electrical terminals. The connector is one of the more expensive components of an EVCS, and it is also the most vulnerable to damage or theft because it is attached to the free end of the power cord provided to reach from the EVCS to the vehicle. Thus, there is a need to protect the electrical connector on the end of the power cord of an EVCS when it is not in use. There is also a need to protect that same connector when it is connected to vehicle during charging, which would also avoid interruptions in the charging operation.

### SUMMARY OF THE INVENTION

The present invention provides an improved locking device that meets all the above objectives with a simple, low-cost mechanism that can be quickly and easily installed in both EVCSs and electric vehicles. This locking device cooperates with the standard latching element provided on the J1772 connector to permit the connector to be locked to either an EVCS or an electric vehicle, and to control the unlocking of the connector.

In accordance with one embodiment, the docking station is provided with a latch-locking device for an electric vehicle charging connector having a movable latching element for engaging a matching latching element on a charging station, or on a vehicle containing a battery to be charged. The latch-locking device includes a movable latch-locking element mounted adjacent the matching latching element on the charging station or vehicle for movement, in a direction transverse to the direction of movement of the movable latching element, between a retracted position spaced away from the matching latching element and an advanced position where the latch-locking element overlaps at least a portion of the movable latching element when the movable latching element is engaged with the matching latching element. An actuator is coupled to the latch-locking element for moving the locking element between the retracted and advanced positions. A second locking element may be provided for locking the latch-locking element in the advanced position.

In one implementation, a housing that supports the movable locking element and the actuator is adapted for mounting adjacent the matching latching element on either a charging station or a vehicle containing a battery to be charged. The housing is adapted to be retrofitted on the charging station or vehicle.

A proximity sensor may be provided for sensing the presence of the movable latching element when it is latched to the matching latching element.

The foregoing and additional aspects of the present invention will be apparent to those of ordinary skill in the art in view of the detailed description of various embodiments, which is made with reference to the drawings, a brief description of which is provided next.

### BRIEF DESCRIPTION OF THE DRAWINGS

The invention may best be understood by reference to the following description taken in conjunction with the accompanying drawings, in which:

FIGS. 1 and 2 are front elevation and perspective views, respectively, of a pedestal-type charging station for electric vehicles, with the pedestal including a docking station for the electrical connector on the end of the power cord to be attached to an electric vehicle.

FIG. 3 is an enlarged side perspective of the electrical connector on the power cord, stowed in the docking station of the pedestal shown in FIGS. 1 and 2.

FIG. 4 is the same perspective shown in FIG. 3, with the mating portions of the connector and the docking station shown in section, with the latching and locking elements in their latched and locked positions.

FIG. 5 is an enlarged perspective of the latching and locking elements shown in FIG. 4.

FIG. 6 is the same perspective shown in FIG. 5, but with the locking element moved to its retracted, unlocked position.

FIG. 7 is a top plan view of the structure shown in FIG. 3.

FIG. 8 is an enlarged section taken along line 8-8 in FIG. 7.

FIG. 8A is a further enlargement of the latching and locking elements shown in FIG. 8, with the locking element retracted to its retracted, unlocked position, and the movable latching element moved to its unlatched position.

FIG. 9 is an enlarged section taken along line 9-9 in FIG. 5

FIG. 9A is a further enlargement of the latching and locking elements shown in FIG. 9, with the locking element retracted to its retracted, unlocked position, and the movable latching element moved to its unlatched position.

FIG. 10 is an exploded perspective view of the components included in the assembly shown in FIG. 3.

FIG. 11 is an exploded perspective view of the electrical connector on the power cord, a portion of a charging receptacle for an electric vehicle, and a modified, manually operated locking device.

FIG. 12A is an enlarged perspective of the distal end of the connector and the locking device shown in FIG. 11, with the locking device in the unlocked position.

FIG. 12B is an enlarged perspective of the distal end of the connector and the locking device shown in FIG. 11, with the locking device in the locked position.

FIG. 13 is an exploded perspective of the locking device shown in FIGS. 11-12A.

FIG. 14 is a rear perspective view of the locking device shown in FIGS. 11-12A, in its unlocked position.

FIG. 15 is a rear perspective view of the locking device shown in FIGS. 11-12A, in its locked position.

### DETAILED DESCRIPTION OF THE ILLUSTRATED EMBODIMENTS

Although the invention will be described in connection with certain preferred embodiments, it will be understood that the invention is not limited to those particular embodiments. On the contrary, the invention is intended to cover all alternatives, modifications, and equivalent arrangements as may be included within the spirit and scope of the invention as defined by the appended claims.

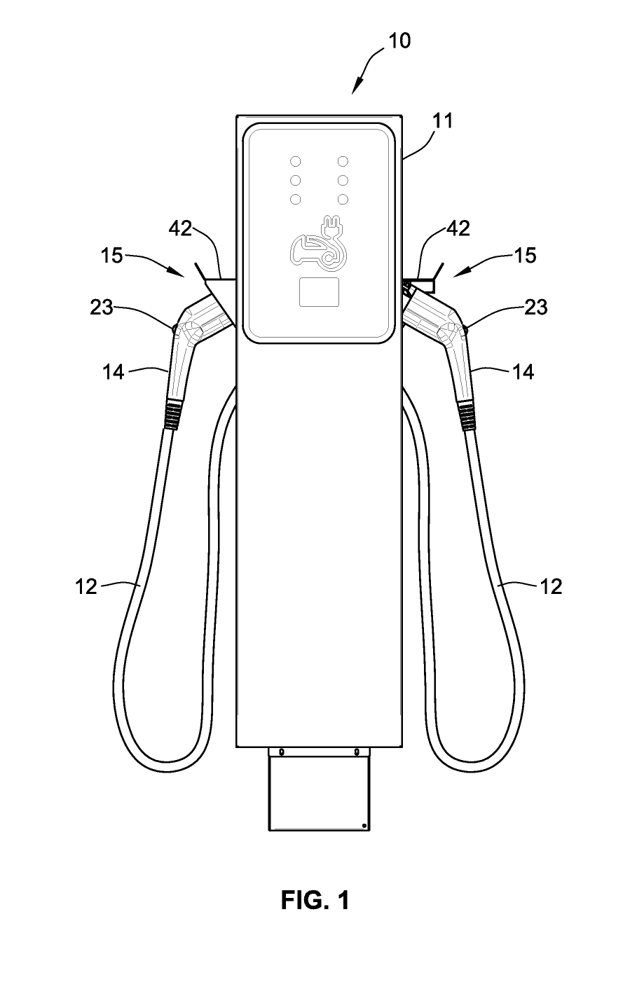

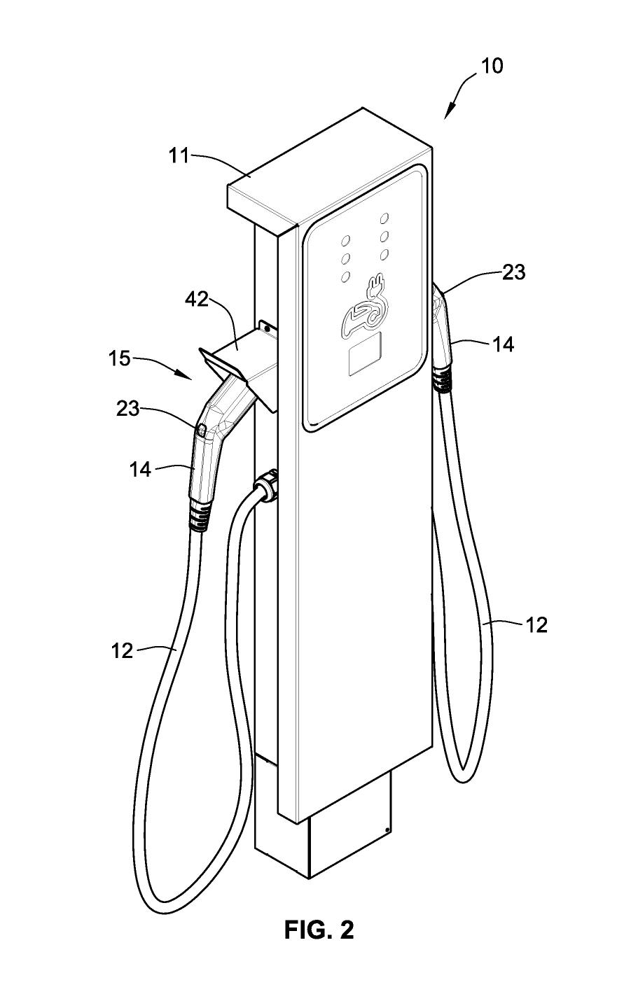

Turning now to the drawings, FIGS. 1 and 2 illustrate an electric vehicle charging station (EVCS) 10 that includes a pedestal 11 connected to an electrical power source such as the local electric utility grid. Electric vehicles are primarily powered by electric motors that draw from a rechargeable energy storage device such as a battery, as well as exchanging information. The vehicle typically has an electrical receptacle for receiving an electrical connector coupled to an electrical power supply for charging one or more batteries in the vehicle. As used herein, the term “electric vehicle” includes both vehicles that use only electrical power and hybrid vehicles in which the power train uses both an electrical power source and an internal combustion engine.

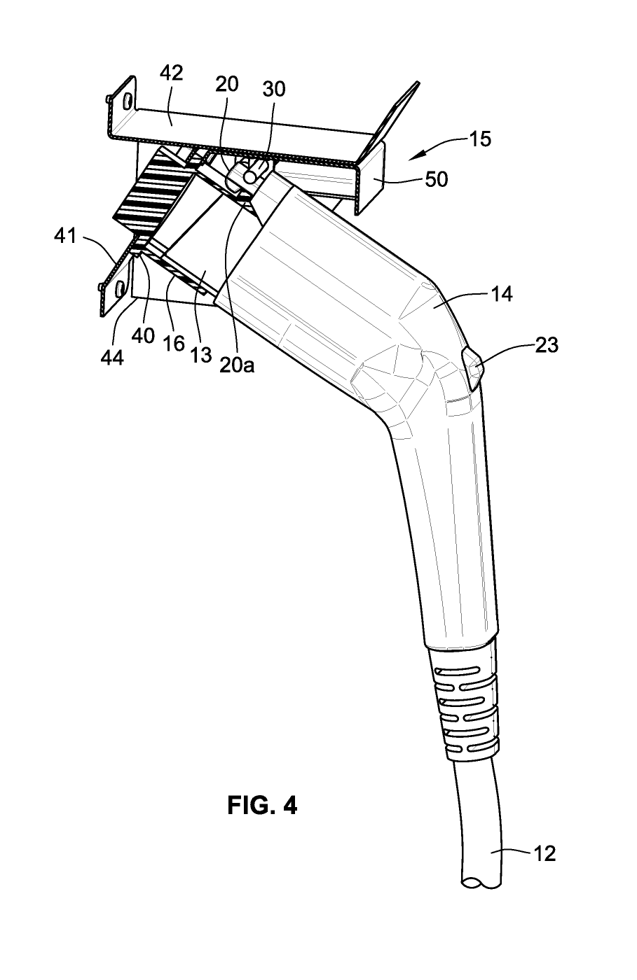

Within the pedestal 11, the electrical power source is connected to one end of a power cable 12 via conventional safety devices such as a circuit breaker or fuse. The other end of the power cable 12 is connected to a first end of an electrical connector 13 (see FIG. 4) contained within a handle 14. The second, open end of the connector 13 includes multiple first electrical terminals adapted to engage mating second electrical terminals in the electrical receptacle that is standard equipment in electric vehicles. As mentioned above, the current standard for electrical connectors for charging electric vehicles in the United States is the SAE J1772 standard, for both the male and female electrical terminals used to connect the battery in an electric vehicle to an EVCS to recharge the vehicle battery. A J1772 connector includes three conductors for connecting the positive, negative and neutral lines of the electrical power source to the positive and negative terminals of the vehicle battery, and a vehicle ground terminal, respectively. The battery then receives and stores electrical power for future use by the vehicle.

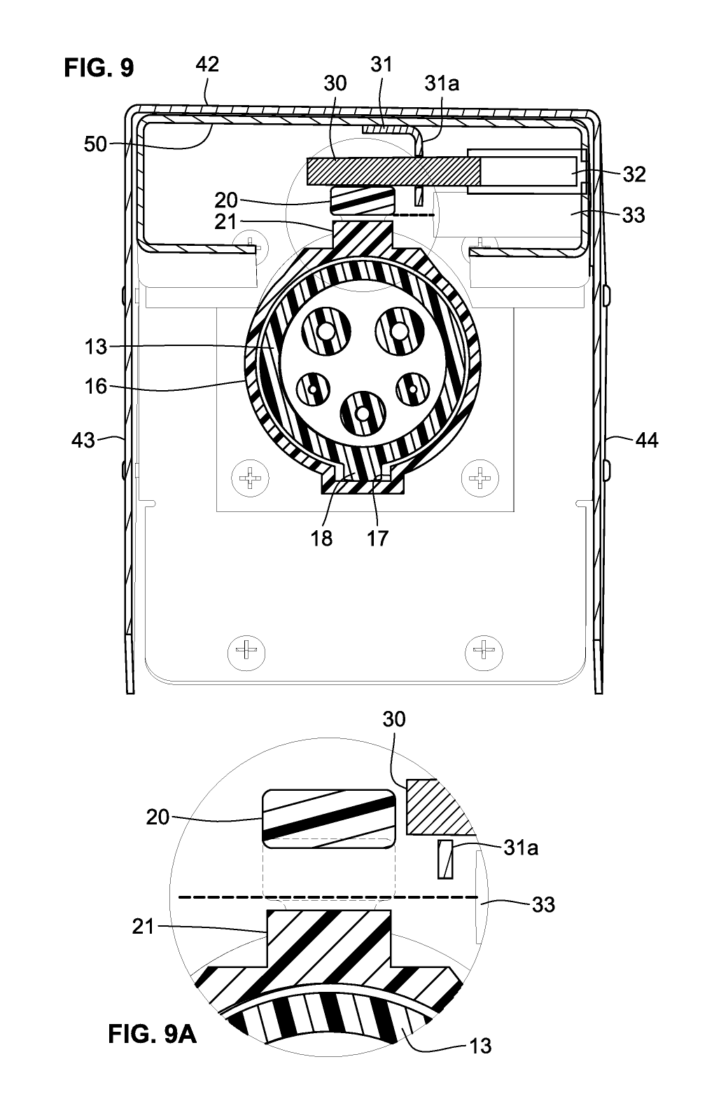

When the charging station 10 is not in use, and the connector 13 is inserted into a docking station 15 on the pedestal 11. The docking station 15 is located at a preselected elevation on the pedestal 11 that is convenient for all users of the charging station 10. The docking station 15 does not include any electrical connectors, but provides physical support and protection for the connector 13 when it is not in use. Specifically, the docking station 15 includes a hollow cylindrical receptacle 16 having an interior configuration that matches the exterior configuration of the connector 13, as can be seen in FIGS. 4 and 8-10. These matching configurations are generally circular, but include a longitudinal groove 17 in the bottom of the receptacle 16 for receiving a matching longitudinal rib 18 on the connector 13 to ensure the proper angular orientation of the connector 13 as it is inserted into the receptacle 16.

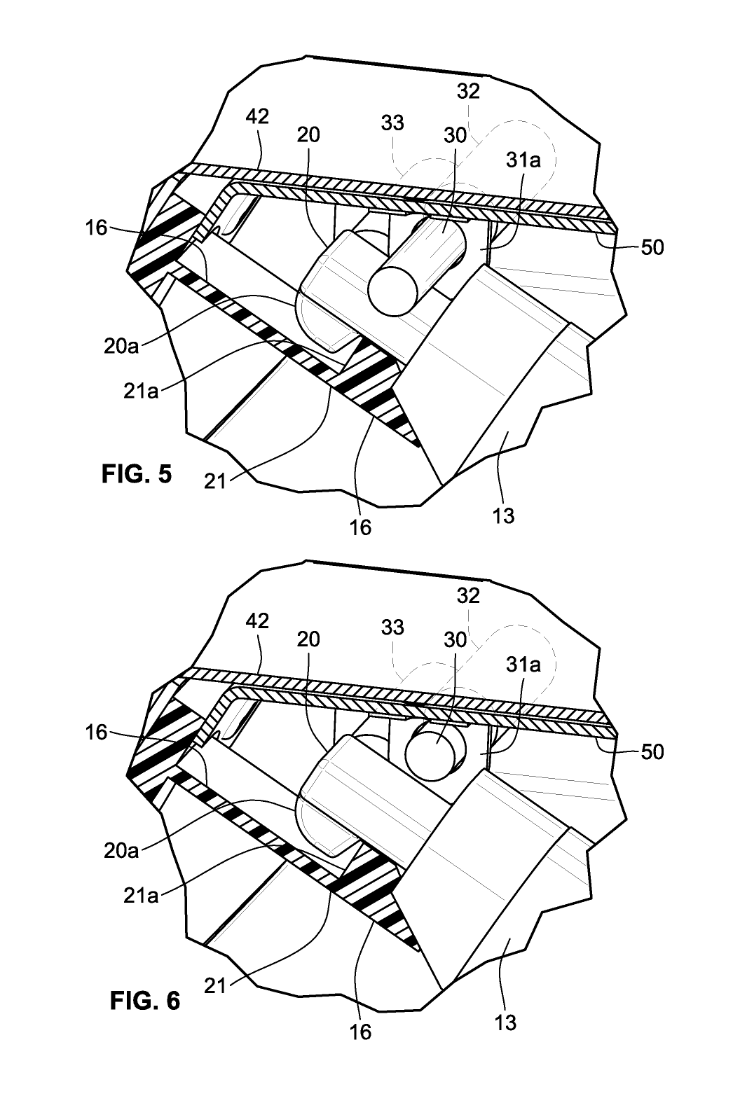

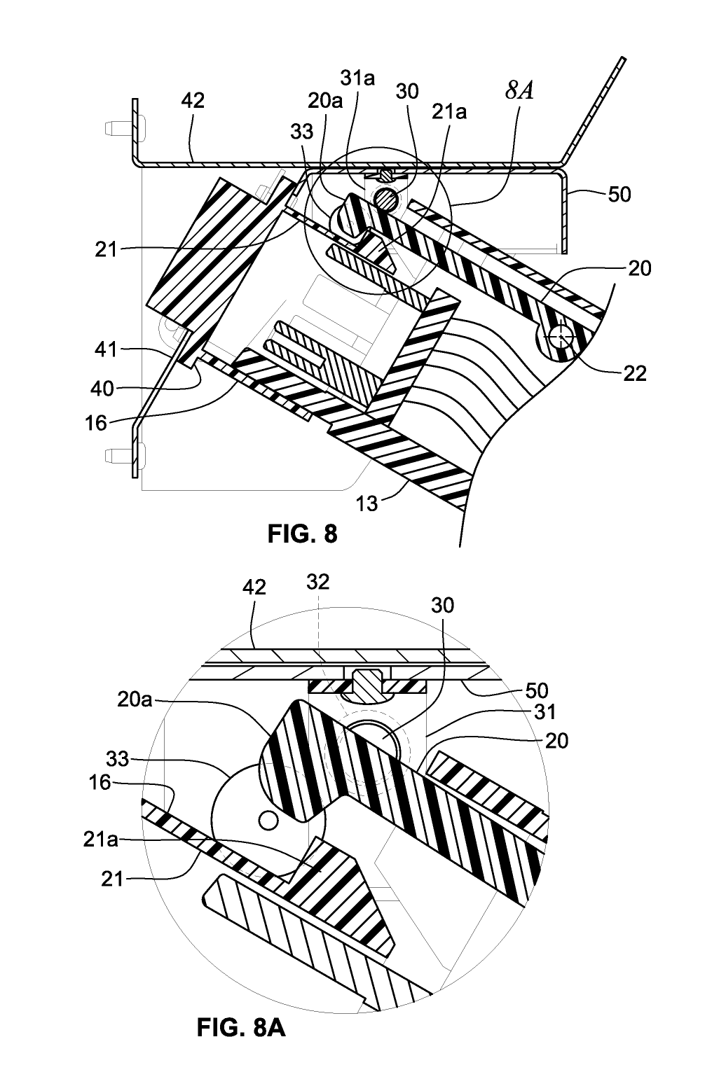

As can be seen in FIGS. 5 and 8, a movable latching element 20 is formed by a spring-loaded detent finger that projects from the top of the connector 13 for fitting over a matching stationary latching element 21 in the stowing receptacle, or in a vehicle receptacle, to prevent inadvertent or accidental decoupling. The mating groove 17 and rib 18 ensure alignment of the two latching elements 20 and 21 with each other, as well as to align the multiple conductors in the connector 13 with the corresponding conductors in the charging receptacle of an electric vehicle. The latching element 20 can enter its socket in the vehicle receptacle only when the connector 13 is in the proper angular position where the conductors in the connector 13 are aligned with their mating conductors in the vehicle receptacle. In both the vehicle receptacle and the docking station, the full latching engagement of the two latching elements 20 and 21 when they snap together provides tactile and audible feedback to the user.

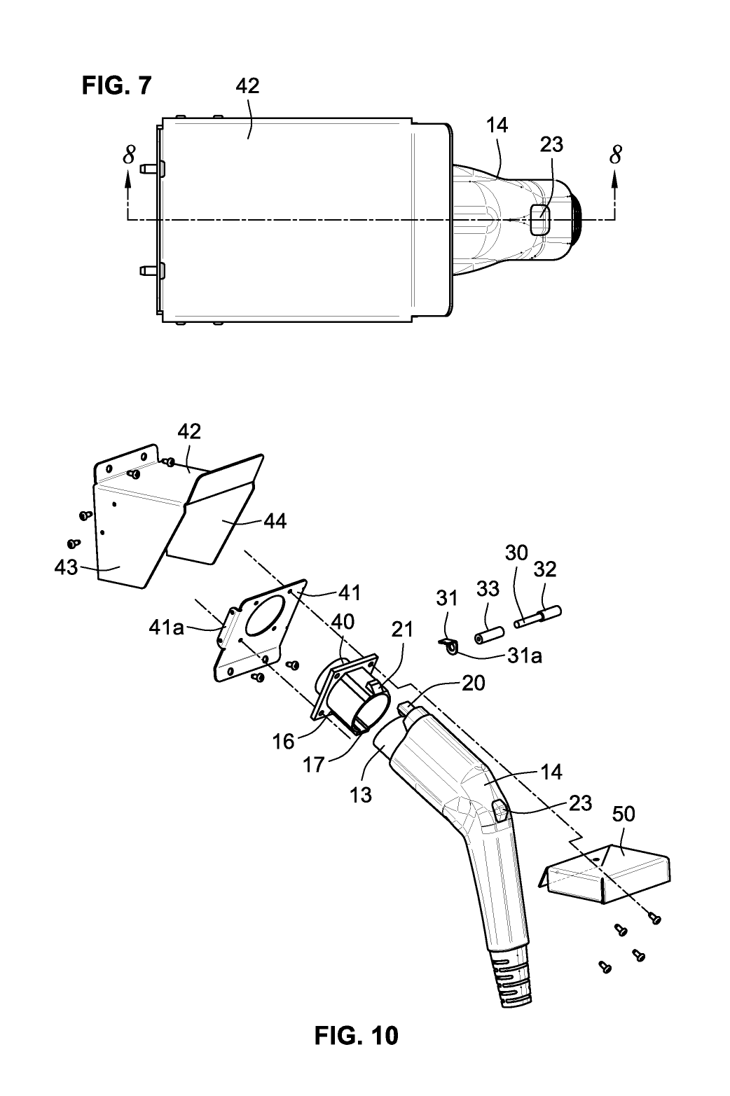

FIGS. 4-8 illustrate the use of the latching element 20 to retain the connector 13 in the docking station 15. As the latching element 20 is pushed into the docking station 15, a depending flange 20a on the front end of the latching element 20 snaps over a flange 21 a on a stationary latching element 21. Thus, the latching element 20 and the handle 14 to which it is attached, cannot be removed from the docking station 15 unless the movable latching element 20 is first disengaged from the stationary latching element 21.

Referring also to FIG. 10, the latching element 20 is pivoted on a shaft 22 (see FIG. 8) so that the front end of the latching element 20 can be pivoted upwardly by pushing down on an actuator button 23 formed as an integral part of the trailing end portion of the latching element 20. The button 23 protrudes out through a hole in the top wall of the handle 14 so that the button 23 is accessible from the exterior of the handle 14, thereby permitting a user to manually press the button 23 to release the latch when it is desired to remove the handle 14 from the docking station 15 (when releasing the connector from a vehicle inlet, the actuator button 23 may also open a switch to trigger a vehicle charge control to provide controlled shutoff of charge power prior to disconnection). Pressing the actuator button 23 tilts the front end of the latching element 20 upwardly against the biasing force of a spring so that the flange 20a clears the latching flange 21a, thereby allowing the handle 14 and the connector 13 to be removed from the docking station 15.

In order to lock the latching element 20 in its latched position where the flanges 20a and 21a overlap each other, a locking rod 30 is mounted for movement between an advanced (locked) position shown in FIG. 5, and a retracted (unlocked) position shown in FIG. 6. In the advanced position, the locking rod 30 extends across the top surface of the latching element 20 so that the element 20 cannot move upwardly to its unlatched position, thus locking the connector 13 in the receptacle that forms the stationary latching flange 21a. To unlock the latch, the locking rod 30 is moved to its retracted position shown in FIGS. 6, 8A and 9A, so that the latching element 20 is free to move upwardly to its unlatched position. This unlocks the connector 13 so that it can be removed from the receptacle in which it is docked or connected for charging. The position of the axis of the locking rod 30 is fixed by a guide bracket 31 attached to a housing 50 (described below). The bracket 31 includes an apertured tab 31a through which the locking rod 30 passes as it moves between its advanced and retraced positions.

In the embodiment of FIGS. 4-11, movement of the locking rod 30 is effected by a linear electrical actuator 32 attached to the outboard end of the rod 30, so that advancing and retracting movement of the rod 30 may be controlled by electrical signals that control the energization and de-energization of the actuator 32. Such actuators are commercially available, such as the “Quickshaft” linear DC servomotors available from Dr. Fritz Faulhaber GMBH & Co. To provide an electrical signal indicating the presence or absence of the movable latching element 20 in the receptacle 30, a proximity sensor 33 is mounted directly adjacent the top surface of the stationary latching flange 21. The output signal from the proximity sensor 33 can be sent to an electrical control system that controls the energization and de-energization of the actuator 32, so that the locking rod 30 is advanced to its locking position only when the signal from the proximity sensor 33 indicates that the latching element 20 is present within the receptacle 16.

For example, the EVCS 10 may include a user interface that requires a user to swipe a payment card (e.g., a credit or debit card) before the connector 13 can be removed from the docking station 15. The swiping of an acceptable card and validation of the data read from the card causes the actuator to be energized to retract the locking rod 30, thereby permitting the user to remove the connector 13 from the docking station 15 and connect it to the charging receptacle in the user's vehicle. The entry of certain numbers on a keypad, as in a PIN-debit transaction, may also be required.

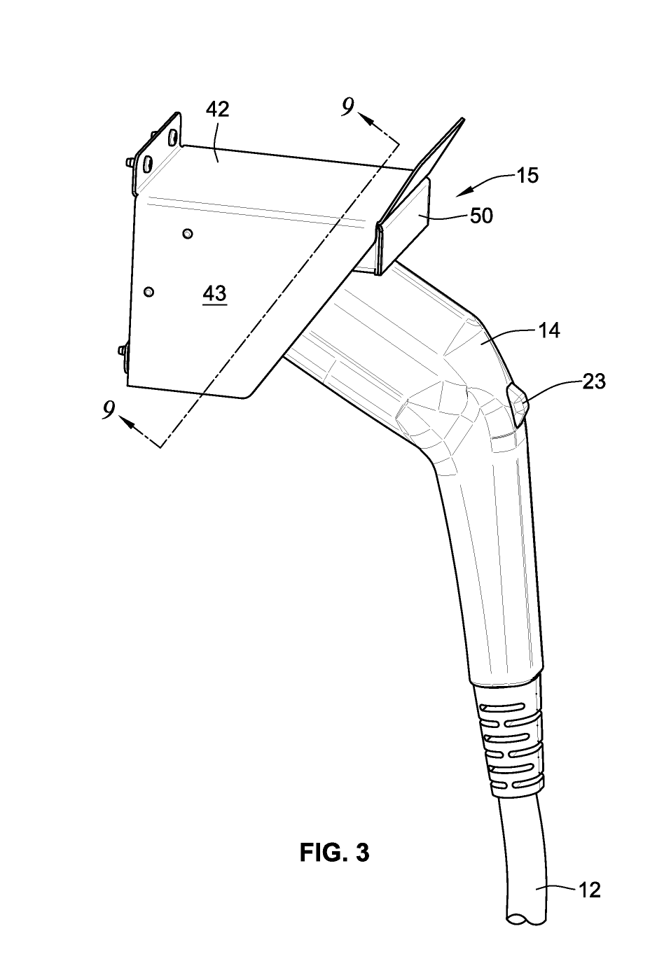

The receptacle 16 includes an outwardly extending flange 40 that is bolted to a mounting plate 41, which in turn is bolted to the charging station pedestal 11. The top edge of the mounting plate 41 is covered by a top plate 42 bolted to the pedestal 11, and the two side edges of the mounting plate 41 include flanges 41a and 42a that are bolted to a pair of side plates 43 and 44. The top plate 41 and the two side plates 43 and 44 can be formed as a single unit of either metal or plastic, as illustrated in FIGS. 3 and 10.

In the illustrative embodiment, the locking device is mounted within a unitary housing 50 that is bolted to the same mounting plate 41 to which the receptacle 16 is bolted. The housing 50 is closed on the top and all four sides, and is open at the bottom to allow space for receiving the upper portion of the connector 13, including the movable latching element 20. This housing 50 can be easily retrofitted to charging station pedestals and also to the charging connectors in electric vehicles with slight modification.

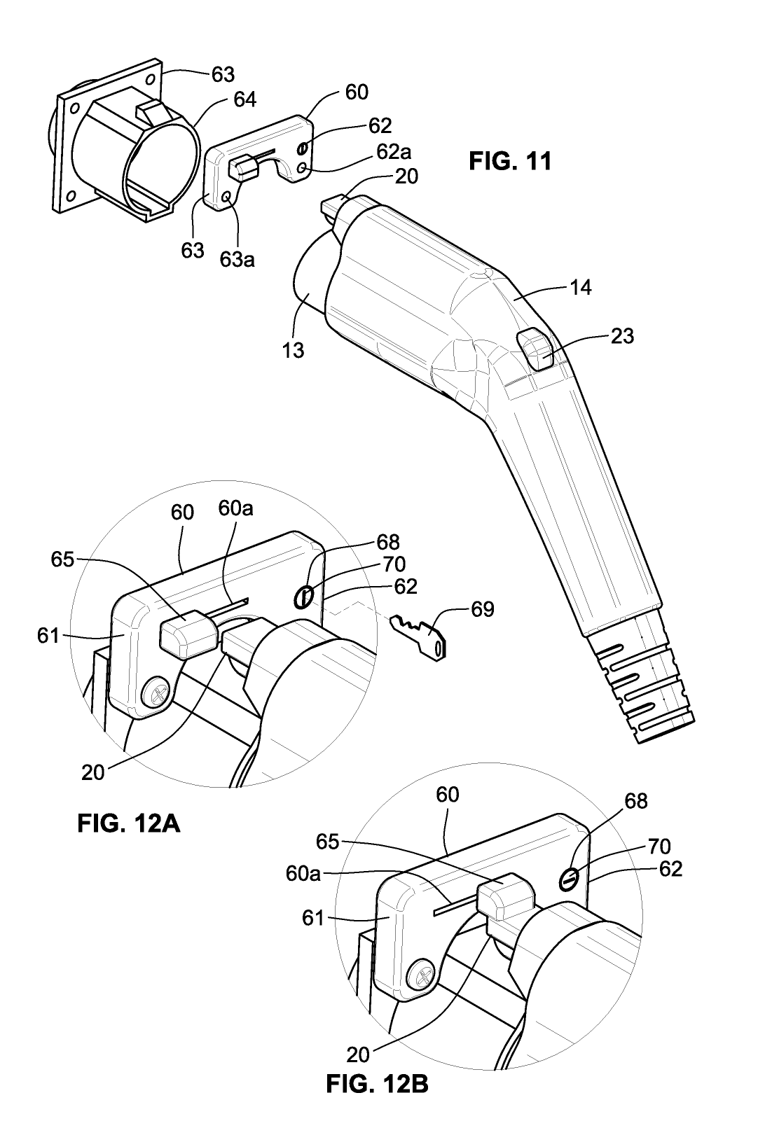

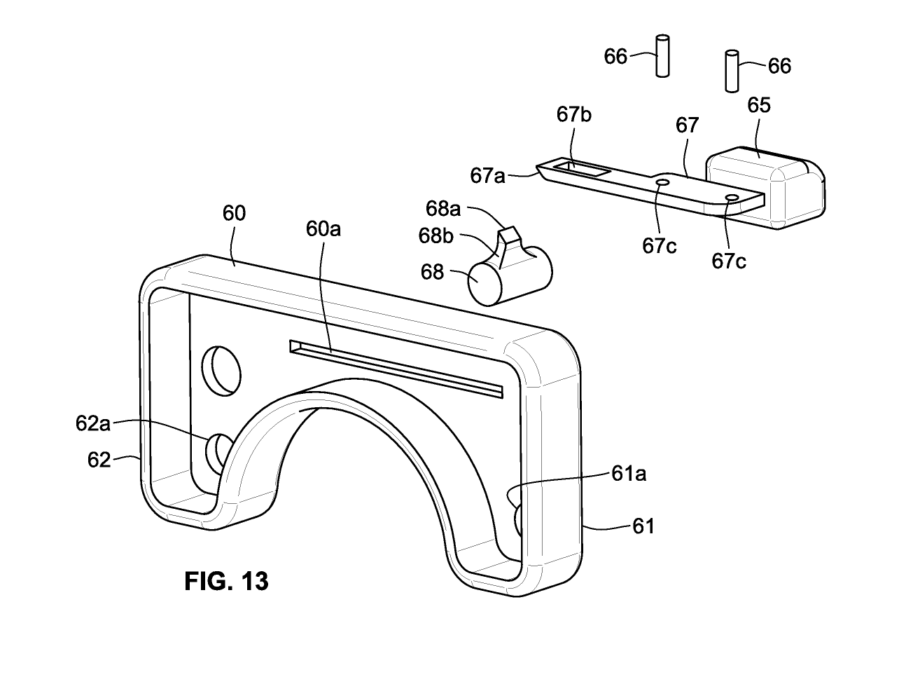

FIGS. 11-15 illustrate an alternative, manually operated locking device that is adapted for use on the charging receptacle in an electric vehicle, to avoid accidental disconnections during charging. This locking device includes a small housing 60 having a pair of depending legs 61 and 62 with apertures 61a and 62a for receiving a pair of bolts to fasten the housing to the upper portion of a mounting plate 63 formed as part of a vehicle receptacle 64 containing the electrical conductors that mate with the conductors in the open end of the connector 13.

The front wall of the housing 60 forms a horizontal slot 60a that receives a latch-locking slide 65 on the front side of the front wall of the housing 60. In FIG. 12A, the slide 65 is located at the left end of the slot 60a, which is the unlocked position where the slide 65 does not engage the latching element 20. In FIG. 12B, the slide 65 has been moved to the right end of the slot 60a, which is the locked position where the slide 65 is aligned with the latching element 20, in engagement with the top surface of the latching element 20 to prevent it from moving to an unlatched position.

To secure the slide 65 in the locked position, an apertured slide-locking element 67 is cantilevered from the back surface of the slide 65 on the rear side of the front wall of the housing 60. As the slide 65 is moved to the left as viewed in

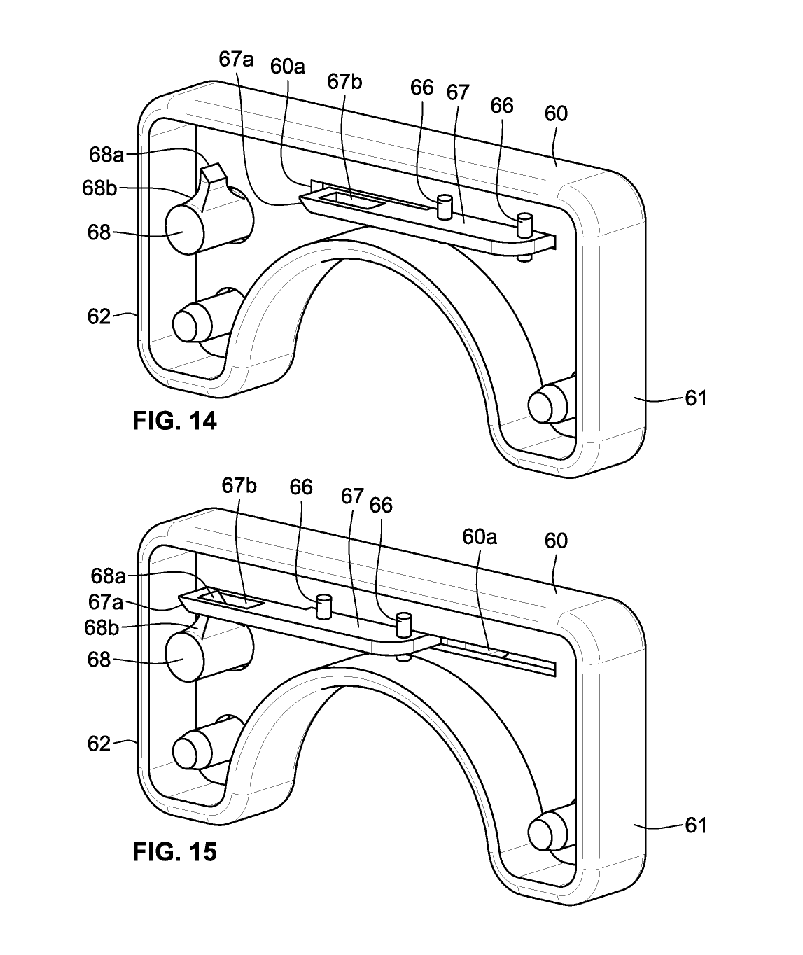

FIGS. 14 and 15 (to the right as viewed in FIGS. 11-12A), a tapered surface 67a on the free end of the cantilevered element 67 engages a complementary tapered surface 68a on the end of a locking finger 68b projecting from a rotatable locking cylinder 68. The cylinder 68 is spring-biased against a stop by a spring (not shown), but can be pivoted against the force of the biasing spring when the slide 65 is moved toward its latch-locking position. As the tapered surface 67a clears the tapered surface 68a, the biasing spring returns the cylinder to its original position, with the finger 68b extending into the aperture 67b of the cantilevered element 67, as shown in FIG. 15, to prevent movement of the slide 65 to its unlocked position.

To unlock the slide 65, the user inserts a key 69 into a keyhole 70 in the front end of the cylinder 68 and turns the cylinder 68 in a clockwise direction, as viewed in FIG. 15. This pivots the finger 68 downwardly through the aperture in the slide 65 to allow the slide to be moved to its unlocked position shown in FIGS. 11 and 12A, which unlocks the movable latching element 20 so that the connector 13 on the power cord can be unplugged from the vehicle receptacle.

The automated actuator 32 can be used in the embodiment of FIGS. 11-15 and coupled to a control circuit that determines when the actuator is energized. For example, the control circuit can monitor the charging of the electric vehicle, and energize the actuator to unlock the slide 65 only when the vehicle battery has been fully charged.

While particular embodiments and applications of the present invention have been illustrated and described, it is to be understood that the invention is not limited to the precise construction and compositions disclosed herein and that various modifications, changes, and variations may be apparent from the foregoing descriptions without departing from the spirit and scope of the invention as defined in the appended claims.

1. A locking device for an electric vehicle charging connector having a movable latching element for engaging a matching latching element on a charging station or an electric vehicle, said locking device comprising
a movable locking element mounted adjacent said matching latching element for movement, in a direction transverse to a direction of movement of said movable latching element, between a retracted position spaced away from said matching latching element and an advanced position where said locking element overlaps at least a portion of said movable latching element when said movable latching element is engaged with said matching latching element, and
an actuator coupled to said locking element for moving said locking element between said retracted and advanced positions.

2. The locking device of claim 1 which includes a housing supporting said movable locking element and said actuator, said housing being adapted for mounting adjacent said matching latching element on a charging station or an electric vehicle.

3. The locking device of claim 2 in which said housing is adapted to be retrofitted on said charging station or an electric vehicle.

4. The locking device of claim 1 which includes a second locking element for locking said movable locking element in said advanced position.

5. The locking device of claim 4 in which said second locking element is key operated.

6. The locking device of claim 1 which includes a proximity sensor for sensing the presence of said movable latching element latched to said matching latching element.

7. The locking device of claim 1 in which said actuator is a linear electrical actuator.

8. The locking device of claim 1 in which said actuator is manually operated.

9. The locking device of claim 1 wherein said movable latching element is a spring-loaded detent fitting over the matching latching element upon full engagement therewith.

10. A docking station for stowing an electric vehicle connector, said connector having a first end connected to a power cable and a second end that includes multiple first electrical terminals adapted to engage mating electrical terminals in an electrical receptacle in said electric vehicle, said second end also including a protruding latching element adapted to engage a cooperating latching element in said electrical receptacle, said docking station comprising
a stowing receptacle adapted to receive said second end of said connector when said connector is not in use, and
a locking device having a movable locking element mounted adjacent said cooperating latching element for movement, in a direction transverse to the direction of movement of said movable latching element, between a retracted position spaced away from said cooperating latching element and an advanced position where said locking element overlaps at least a portion of said protruding latching element when said protruding latching element is engaged with said cooperating latching element, and an actuator coupled to said locking element for moving said locking element between said retracted and advanced positions.

11. The docking station of claim 10 which includes a housing supporting said movable locking element and said actuator, said housing being adapted for mounting adjacent said matching latching element on a charging station or an electric vehicle.

12. The locking device of claim 11 in which said housing is adapted to be retrofitted on said charging station or an electric vehicle.

13. The locking device of claim 10 which includes a second locking element for locking said movable locking element in said advanced position.

14. The locking device of claim 13 in which said second locking element is key operated.

15. The locking device of claim 10 which includes a proximity sensor for sensing the presence of said movable latching element latched to said matching latching element.

16. The locking device of claim 10 in which said actuator is a linear electrical actuator.

17. The locking device of claim 10 in which said actuator is manually operated.

18. The locking device of claim 10 in which said movable latching element is a spring-loaded detent fitting over the matching latching element upon full engagement therewith.
